(19) United States
(12) Patent Application Publication
(10) Pub. No.: US 2016/0012358 A1
(43) Pub. Date: Jan. 14, 2016

(54) CAMPAIGN ORGANIZATION SYSTEM

(71) Applicant: CROWDPLSR, INC., Allentown, PA (US)

(72) Inventors: George Richie, Allentown, PA (US); Jeffrey Minton, Allentown, PA (US)

(21) Appl. No.: 14/795,617

(22) Filed: Jul. 9, 2015

Related U.S. Application Data
(60) Provisional application No. 62/023,583, filed on Jul. 11, 2014.

(51) Int. Cl. G06Q 10/06; G07C 13/00; G06Q 30/02

(52) U.S. Cl. CPC G06Q 10/0631; G06Q 30/0207; G06Q 30/0252; G06Q 30/0261; G06Q 30/0219; G07C 13/00; G06Q 30/0217

(57) ABSTRACT

A Crowdplsr system organizes campaigns that are funded by users. The Crowdplsr system includes a funding phase, a selection phase, and a rewards phase. During the funding phase, the Crowdplsr system controls the defining by a campaign organizer of a campaign, defining by option creators of options for the campaign, and funding by funding users of the options. In the selection phase, the Crowdplsr system controls the selecting by the campaign organizer of an option for the campaign based, at least in part, on the funding of the funding users. In the rewards phase, the Crowdplsr system controls the rewarding of funding users for funding the selected option.

### CROSS REFERENCE TO RELATED MATTER

This application claims the benefit of U.S. Provisional Application No. 62/023,583, filed Jul. 11, 2014, and entitled “EVENT ORGANIZATION SYSTEM,” which is incorporated herein in its entirety by reference.

### BACKGROUND

Today, event organizers deliver event offerings to the marketplace via a push strategy or, more simply put, a guess and check strategy. Event organizers guess on the demand for a particular event and check their hypotheses only after they have committed their resources and “pushed’ the event onto the marketplace. Because demand is difficult to estimate and there is no mechanism in place to accurately assess demand, estimates can be inaccurate and, therefore, events that may be in high demand in a particular market can be overlooked, ultimately, leaving unsatisfied demand amongst fans in that market who do not have the means, know-how, and/or willingness to organize events that they want to attend by themselves. The push strategy is also utilized by companies and other organizations to deliver product and service offerings and causes to the marketplace and results in unsatisfied demand amongst consumers and advocates who do not have the means, know-how, and/or willingness to produce products and services and advance causes, respectively.

### BRIEF DESCRIPTION OF THE DRAWINGS

FIG. 1 is a block diagram that illustrates components of the Crowdplsr system supporting tour campaigns in some embodiments.

FIG. 2 is a flow diagram illustrating the overall flow of the processing of a tour campaign of the Crowdplsr system in some embodiments.

FIG. 3 is a flow diagram illustrating the overall flow of the processing of a fan's choice campaign of the Crowdplsr system in some embodiments.

FIG. 4 is a flow diagram illustrating the overall flow of the processing of an event campaign created by a fan in some embodiments.

FIG. 5 is a flow diagram that illustrates the overall flow of the processing of an event campaign created by an event organizer in some embodiments.

FIG. 6 is a block diagram illustrating the tables of the database of the Crowdplsr system supporting event campaigns created by a fan or an event organizer in some embodiments.

### DETAILED DESCRIPTION

Crowdplsr (“Crowd pleaser”) is a campaign organization system that empowers fans to drive events that they want to attend to their market and enable event organizers to give people what they want by providing an online platform that fans can use to demonstrate their level of demand for and fund particular events to influence event offerings in their market. A web and mobile based crowdfunding application allows users to raise funds for events that they want to attend in their market. Event organizers will be able to create campaigns to raise funds for events that they are considering. The Crowdplsr system allows fans to initiate campaigns to raise funds for events that they want to attend in their market.

In some embodiments, a Crowdplsr system organizes campaigns. The Crowdplsr system includes a funding phase component for defining by a campaign organizer of a campaign (e.g., performance by a performer, defining by option creators options for the campaign (e.g., venues for a performance), and funding by funding users the option. The Crowdplsr system also include a selection phase component for selecting by the campaign organizer an option for the campaign (e.g., venues for performances) based, at least in part, on the funding of the funding users. The Crowdplsr system also includes a rewards phase component for rewarding funding users (e.g., providing tickets to a performance) for funding the selected option. The Crowdplsr system may also include a terminal phase component to allow users, including non-funding users, to participate (e.g., purchase tickets for performances) in the selected option of the campaign.

In some embodiments, the campaign may be a tour campaign (e.g., for performances of a performer) and the defining of the campaign may include specifying an offering and the defining of options includes specifying a proposed offering market for the offering. An offering may be a performance and the proposed offering market specifies a location for an occurrence of the performance. An offering may also be a product or service and the proposed offering market specifies a location for offering the product or service. An offering may be a cause and the proposed offering market specifies a location where the cause is to be promoted. In addition, the rewards phase component may reward funding users by providing the offering to the funding users based on their funding of a proposed offering market.

In some embodiments, the campaign may be a fan's choice campaign (e.g., for performer to perform at a venue) and the defining of the campaign may include specifying an offering market (e.g., a venue) and the defining of options may include specifying a proposed offering (e.g., performers). An offering market may be a location for an offering and a proposed offering may a performance for the location. An offering market may be a location and the proposed offering may be a product or a service to be available at the location. An offering market may also be a location and the proposed offering may be a cause to be promoted at the location. In addition, the rewards phase component may reward funding users by providing the offering to the funding users based on their funding of a proposed offering.

In some embodiments, the Crowdplsr system organizes campaigns proposed by users. The Crowdplsr system receives from a campaign organizer a definition of a campaign having an offering (e.g., performer) for an offering market (e.g., city). The Crowdplsr system receives an indication of a funding by funding users of the offering and receives bids (e.g., from promoters) to fulfill the offering at the offering market. The Crowdplsr system receives from funding users votes for a received bid and receives from the campaign organizer a selection of a bid based, at least in part, on votes of the funding users. The Crowdplsr system then provides a reward (e.g., tickets) to funding users for funding the selected offering. An offering may be a performance, and the offering market may specify a location for the performance. An offering may be a product or service, and the offering market may specify a location for offering the product or service. An offering may be a cause, and the offering market may specify a location where the cause is to be promoted.

In some embodiment, the Crowdplsr system organizes a tour campaign for an event. The Crowdplsr system controls the defining by a campaign organizer of the event for the campaign and the defining by event market creators of proposed markets for occurrences of the event. The Crowdplsr system then controls the funding by funding users of the proposed markets. The Crowdplsr system then controls the selecting by the campaign organizer of proposed markets for the campaign based, at least in part, on the funding of the funding users. The Crowdplsr system then controls the rewarding of funding users for funding the selected proposed markets. The event may be a performance by a performer, and the proposed markets may specify proposed venues for performances. The funding users may be rewarded with tickets to occurrences of the event in exchange for their funding. The Crowdplsr system may also control the allowing of non-funding users to purchase tickets after the funding users are rewarded.

### I. Tour Campaigns (Created by Event Organizer)

In some embodiments, Crowdplsr's tour campaigns allows event organizers, who are setting up a multi-market tour for a single performer; static group of performers; or event, to determine which markets have the highest demand for the performer(s) or event and, ultimately, which markets they will be scheduling performances in for the tour. Tour campaigns go through four phases: funding, selection, rewards, and event.
1. Funding Phase

Any event organizer can create a tour campaign (i.e., campaign) to determine which markets have the highest demand for a performer, group of performers, or an event. In doing so, the event organizer who may be an organization or person including a performer, will specify the desired feature or entertainment of the event, which amenities they will offer at each event, and an expiration date as to when the event campaigns will expire if they are not selected. At this point, the tour campaign will be on display to all users in the Crowdplsr community and the tour campaign creator (i.e., campaign creator) or any other user can share that event campaign with those in their extended network. For example, they may share via social networks, blogs, email, mobile contact lists, and other mediums. Within the tour campaign, fans from different markets can create event campaigns to demonstrate their level of demand for the specified performer or event. In doing so, the event campaign creator (i.e., option creator) will select a general location or proximity (i.e., option or offering) where they hope for the event to take place. At this point, the event campaign begins the funding phase, where event campaign creator and other users interested in attending the specified event in the specified market can demonstrate their level of interest by committing funds to the event campaign. Moreover, the event campaign creator or any other user can share that event campaign with those in their extended network. Throughout each phase, the event campaign will be on display to all users including event organizers. There may or may not be minimum or target amount of funding that needs to be raised. The event campaign can raise funds until it reaches the rewards phase or the expiration date.
2. Selection Phase

Event campaigns (within the tour campaign) that raise a substantial amount of funds or interest can be selected by the tour campaign creator to organize the event in the location specified by the event campaign. The selection phase begins at the discretion of the tour campaign creator before the expiration date specified in the tour campaign. In making a selection, the tour campaign creator will specify where they will hold the event, when the event will take place, what price they will sell tickets to the users who funded the event campaign, and the maximum number of tickets that each person can purchase. The event organizer can select as many event campaigns (within the tour campaign) as they choose, but cannot select any event campaigns after the specified expiration date. Those event campaigns not selected cease to exist.
3. Rewards Phase

Once an event campaign is selected, that event campaign begins the rewards phase. Those users who committed funds to the event campaign will have an opportunity to purchase tickets to the event at the ticket price specified in the selection phase before they are available to the general public. The funds that the user has already committed to the event campaign can be used as credit towards purchasing tickets. For example, if a user has committed $30 to the event campaign and the price of tickets are $20 each, then that user has the option to purchase one ticket and forfeit their additional $10 credit or commit additional funds to purchase more than one ticket. Each user will be limited to purchasing a maximum number of tickets that is specified in the selection phase. The rewards phase ceases after a specified time and, at that point, the users who committed funds to the event campaign may no longer be able to purchase tickets at the price specified in the selection phase, but may be able to use the funds they committed as credit towards those purchases at the prevailing ticket price.
4. Event Phase

Upon the completion of the rewards phase, the event campaign reaches the final stage: the event phase. In the event phase, the event organizer will have the opportunity to sell tickets to the event via the Crowdplsr platform. During the event phase, the price of tickets can be changed at any time by the event organizer. Tickets can be sold until there are none remaining or the event commences.

Crowdplsr will support any type of event, such as live music concerts, theatre, non-franchise sports, comedy, festivals, speakers (e.g., educational, motivational, religious, and political), tradeshows and celebrity appearances.
5. Applicability to Products and Services

In addition to events, the Crowdplsr system is applicable to products or services. Specifically, tour campaigns created by a product or service provider could be utilized to determine which markets have the highest demand for a product or service and, ultimately, which markets to make a product or service available in. Like event organizers in a tour campaign, product or service providers who want to make a product or service available in one or more markets, but do not have the means, know-how, and/or willingness to calculate the demand for the product or service in one or more markets can create a tour campaign to determine the amount of demand for the product or service in every market they choose. A tour campaign created by a product or service provider will allow people to demonstrate their level of demand for the specified products or services within the market they reside in. This type of campaign, like the tour campaign created by an event organizer, has four phases: funding, selection, rewards, and product or service. These phases function similar to those in the tour campaign created by an event. Similar to fans in a tour campaign created by an event organizer, individuals will be able to create and/or commit funds to product or service campaigns within the tour campaign to demonstrate their level of demand for the specified product or service within their markets. Like event organizers in a tour campaign, the product or service provider who created the tour campaign will select one or more product or service campaigns and will make their product or service available in the market(s) specified within the selected campaign(s). In the rewards phase, individuals who committed funds to the selected campaign(s) will be able to purchase the product or service detailed by the tour campaign at the specified price before the product or service is available to the general public. The product or service phase is the equivalent of the event phase in a tour campaign created by an event organizer, however, the product or service detailed in the campaign will be sold through the platform instead of tickets.
6. Applicability to Causes

In addition to events, the Crowdplsr system is applicable to causes. Specifically, tour campaigns created by an organization could be utilized to determine which markets have the highest demand for a cause and, ultimately, which markets to implement initiatives to advance a cause in. Like event organizers in a tour campaign, organizations who want to advance a cause in one or more markets, but do not have the means, know-how, and/or willingness to calculate the demand for the cause in one or more markets can create a tour campaign to determine the amount of demand for the cause in every market they choose. A tour campaign created by an organization will allow people to demonstrate their level of demand for the specified cause within the market they reside in. This type of campaign, like the tour campaign created by an event organizer, has four phases: funding, selection, rewards, and cause. These phases function similar to those in the tour campaign created by an event organizer. Similar to fans in a tour campaign created by an event organizer, individuals will be able to create and/or commit funds to cause campaigns within the tour campaign to demonstrate their level of demand for the specified cause within their markets. Like event organizers in a tour campaign, the organization who created the tour campaign will select one or more cause campaigns and will advance the specified cause in the market(s) specified within the selected campaign(s). In the rewards phase, individuals who committed funds to the selected campaign(s) will receive official documentation from the organization indicating their engagement, duration of engagement, and detailing their services to be performed to advance the specified cause. The cause phase is the equivalent of the event phase in a tour campaign created by an event organizer except, instead of selling tickets, the organization can continue to raise funds to provide additional services and lengthen their duration of engagement with those who want to advance the cause specified in the campaign.

### II. Fan'S Choice Campaign (Created by Event Organizer)

In some embodiments, Crowdplsr's fan's choice campaigns allows event organizers, who are setting up one or more performance; festival; or event, to determine which performers or event attractions have the highest demand within the market that the event will be taking place and, ultimately, which performers or event attractions they will be scheduling for the events. Fan's Choice campaigns go through four phases: funding, selection, rewards, and event.
1. Funding Phase

Any event organizer can create a fan's choice campaign (i.e., campaign) to determine which performers or event attractions have the highest demand within a particular market. In doing so, the event organizer will specify the general or specific location where the event will take place, which amenities they will offer at each event, and an expiration date as to when the event campaigns will expire if they are not selected. At this point, the fan's choice campaign will be on display to all users in the Crowdplsr community and the fan's choice campaign creator (i.e., campaign creator) or any other user can share that event campaign with those in their extended network. For example, they may share via social networks, blogs, email, mobile contact lists, and other mediums. Within the fan's choice campaign, fans can create event campaigns to demonstrate their level of demand for a performer or event attraction. In doing so, the event campaign creator (i.e., option creator) will specify the desired performer (e.g., option or offering) or event attraction of the event. At this point, the event campaign begins the funding phase, where event campaign creator and other users interested in attending the specified event can demonstrate their level of interest by committing funds to the event campaign. Moreover, the event campaign creator or any other user can share that event campaign with those in their extended network. Throughout each phase, the event campaign will be on display to all users including event organizers. There may or may not be minimum or target amount of funding that needs to be raised. The event campaign can raise funds until it reaches the rewards phase or the expiration date.
2. Selection Phase

Event campaigns (within the fan's choice campaign) that raise a substantial amount of funds or interest can be selected by the fan's choice campaign creator to feature the performer or event attraction specified by the event campaign at the event specified by the fan's choice campaign. The selection phase begins at the discretion of the fan's choice campaign creator before the expiration date specified in the fan's choice campaign. In making a selection, the fan's choice campaign creator will specify where they will hold the event, when the event will take place, what price they will sell tickets to the users who funded the event campaign, and the maximum number of tickets that each person can purchase. The event organizer can select as many event campaigns (within the fan's choice campaign) as they choose, but cannot select any event campaigns after the specified expiration date. Those event campaigns not selected cease to exist.
3. Rewards Phase

Once an event campaign is selected, that event campaign begins the rewards phase. Those users who committed funds to the event campaign will have an opportunity to purchase tickets to the event at the ticket price specified in the selection phase before they are available to the general public. The funds that the user has already committed to the event campaign can be used as credit towards purchasing tickets. For example, if a user has committed $30 to the event campaign and the price of tickets are $20 each, then that user has the option to purchase one ticket and forfeit their additional $10 credit or commit additional funds to purchase more than one ticket. Each user will limited to purchasing a maximum number of tickets that is specified in the selection phase. The rewards phase ceases after a specified time and, at that point, the users who committed funds to the event campaign may no longer be able to purchase tickets at the price specified in the selection phase, but may be able to use the funds they committed as credit towards those purchases at the prevailing ticket price.
4. Event Phase

Upon the completion of the rewards phase, the event campaign reaches the final stage: the event phase. In the event phase, the event organizer will have the opportunity to sell tickets to the event via the Crowdplsr platform. During the event phase, the price of tickets can be changed at any time by the event organizer. Tickets can be sold until there are none remaining or the event commences.

Crowdplsr will support any type of event, such as live music concerts, theatre, non-franchise sports, comedy, festivals, speakers (e.g., educational, motivational, religious, and political), tradeshows and celebrity appearances.
5. Applicability to Products and Services

In addition to events, the Crowdplsr system is applicable to products or services. Specifically, fan's choice campaigns created by a product or service provider could be utilized to determine which products or services have the highest demand within a specific market and, ultimately, which products or services to make available in that market. Like event organizers in a fan's choice campaign, product or service providers who want to make one or more products or services available in a specific market, but do not have the means, know-how, and/or willingness to calculate the demand for products or services or variations of products or services in a specific market can create a fan's choice campaign to determine the products or services that have the highest demand in the specified market. This type of campaign, like the fan's choice campaign created by an event organizer, has four phases: funding, selection, rewards, and product or service. These phases function similar to those in the fan's choice campaign created by an event organizer. Similar to fans in a fan's choice campaign created by an event organizer, individuals will be able to create and/or commit funds to product or service campaigns within the fan's choice campaign to demonstrate their level of demand for products or services within the specified market. Like event organizers in a fan's choice campaign, the product or service provider who created the fan's choice campaign will select one or more product or service campaigns and will make the product(s) or service(s) specified in the selected campaign(s) available in the specified market. In the rewards phase, individuals who committed funds to the selected campaign(s) will be able to purchase the product(s) or service(s) detailed by the selected campaign(s) at the specified price before the product or service is available to the general public. The product or service phase is the equivalent of the event phase in a fan's choice campaign created by an event organizer, however, the product(s) or service(s) detailed in the selected campaign(s) will be sold through the platform instead of tickets.
6. Applicability to Causes

In addition to events, the Crowdplsr system is applicable to causes. Specifically, fan's choice campaigns created by an organization could be utilized to determine which causes have the highest demand within a specific market and, ultimately, which causes to advance in that market. Like event organizers in a fan's choice campaign, organizations who want to advance one or more causes in a specific market, but do not have the means, know-how, and/or willingness to calculate the demand for causes in a specific market can create a fan's choice campaign to determine the causes that have the highest demand in the specified market. This type of campaign, like the fan's choice campaign created by an event organizer, has four phases: funding, selection, rewards, and cause. These phases function similar to those in the fan's choice campaign created by an event organizer. Similar to fans in a fan's choice campaign created by an event organizer, individuals will be able to create and/or commit funds to cause campaigns within the fan's choice campaign to demonstrate their level of demand for causes within the specified market. Like event organizers in a fan's choice campaign, the organization who created the fan's choice campaign will select one or more cause campaigns and will advance the cause(s) specified in the selected campaign(s) in the specified market. In the rewards phase, individuals who committed funds to the selected campaign(s) will receive official documentation from the organization indicating their engagement, duration of engagement, and detailing their services to be performed to advance the specified cause. The cause phase is the equivalent of the event phase in a fan's choice campaign created by an event organizer except, instead of selling tickets, the organization can continue to raise funds to provide additional services and lengthen their duration of engagement with those who want to advance the cause specified in the campaign.

### III. Event Campaigns Created by a Fan

In some embodiments, event campaigns are initiated by fans. Crowdplsr's event campaigns that are created by fans allow people to demonstrate their level of demand for events that they want to attend and pull these events to their market or, in other words, prompt these events to take place in their market. Event campaigns created by fans go through four phases: funding, voting, rewards, and event.
1. Funding Phase

Any fan can create an event campaign to raise funds for an event that they want to attend. In doing so, the event campaign creator will describe the desired feature or entertainment of the event, select a general location or proximity where they hope for the event to take place, and set an expiration date as to when the event campaign ceases if it does not receive a winning bid. At this point, the event campaign begins the funding phase, where event campaign creator and other users interested in attending the specified event can demonstrate their level of interest by committing funds to the event. Moreover, the event campaign creator or any other user can share that event campaign with those in their extended network. For example, they may share via social networks, blogs, email, mobile contact lists, and other mediums. Throughout each phase, the event campaign will be on display to all users including event organizers. There may or may not be a minimum or target amount of funding that needs to be raised. The event campaign can raise funds until it reaches the rewards phase.
2. Voting Phase

Event campaigns that describe enticing event ideas and/or raise a substantial amount of funds can be bid on by interested event organizers. Any event organizer that is interested in using the funds raised by the event campaign to organize the event that is specified by the event campaign can bid on the funds raised by that event campaign. To place a bid, the event organizer will propose where they will hold the event, when the event will take place, what price they will sell tickets to the users who funded the campaign, and which amenities they will offer at the event. After a bid is made on the event campaign by one or more event organizer(s), the event campaign enters the voting phase and a notification will automatically be sent to all users who funded the campaign indicating that a vote will take place in, for example, one week after the first bid was made or at some other time. Each user may receive one vote for every dollar they committed to funding the campaign. Once the voting period begins, each user can either vote for the bid that they believe to be is most favorable or indicate that none of the bids are sufficient. Additionally, the Crowdplsr system may allow user to change their vote at any point until the voting period has ended. At the end of the voting period, the results are tallied and if any bid receives a majority of the votes, the funds raised by the event campaign are transferred to the winning bidder and the event campaign begins the rewards phase. Otherwise, the event campaign reverts to the funding phase. Event organizers can bid on event campaigns until that campaign reaches the rewards phase.
3. Rewards Phase

Once a winning bidder is selected and the event campaign begins the rewards phase, those users who committed funds to the event campaign will have an opportunity to purchase tickets to the event at the specified ticket price in the winning bid before they are available to the general public. The funds that the user has already committed to the event campaign can be used as credit towards purchasing tickets. For example, if a user has committed $30 to the event campaign and the price of tickets are $20 each, then that user has the option to purchase one ticket and forfeit their additional $10 credit or commit additional funds to purchase more than one ticket. Each user may be limited to purchasing a maximum number of tickets that is specified in the winning bid. The rewards phase ceases after a specified time and, at that point, the users who committed funds to the event campaign may no longer be able to purchase tickets at the price specified by the winning bid, but may be able to use the funds they committed as credit towards those purchases at the prevailing ticket price.
4. Event Phase

Upon the completion of the rewards phase, the event campaign reaches the final stage: the event phase. In the event phase, the event organizer, who now controls the event campaign, will have the opportunity to sell tickets to the event via the Crowdplsr platform. During the event phase, the price of tickets can be changed at any time by the event organizer. Tickets can be sold until there are none remaining or the event commences.

The Crowdplsr system may support any type of event, such as live music concerts, theatre, non-franchise sports, comedy, festivals, speakers (e.g., educational, motivational, religious, and political), tradeshows and celebrity appearances.
5. Applicability to Products and Services

In addition to events, the Crowdplsr system is applicable to products or services. Specifically, product or service campaigns created by an individual could be utilized to bring a product or service to market. Like fans in an event campaign created by a fan, individuals who want a product or service to come to market, but do not have the means, know-how, and/or willingness to bring that product or service to market can create a product or service campaign to bring that product or service to their market. A product or service campaign created by an individual will allow people to initiate product or service ideas and demonstrate their level of demand for those products or services. This type of campaign, like the event campaign created by a fan, has four phases: funding, voting, rewards, and product or service. These phases function similar to those in the event campaign created by a fan. Like event organizers in an event campaign created by a fan, companies who have the capability to bring products and/or services to the market can bid on the funds raised by a campaign to utilize those funds to bring the specified product or service to market. In the rewards phase, individuals who contributed to the campaign will be able to purchase the product or service detailed by the campaign at the price specified in the winning bid before the product or service is available to the general public. The product or service phase is the equivalent of the event phase in an event campaign created by a fan, however, the product or service detailed in the campaign will be sold through the platform instead of tickets.
6. Applicability to Causes

In addition to events, the Crowdplsr system is applicable to causes. Specifically, cause campaigns created by an individual could be utilized to bring a cause to market and influence legislation or decisions made by the government (whether local, state, or federal) or advance the cause through other initiatives. Like fans in an event campaign created by a fan, individuals who want to influence legislation or decisions made by the government or advance a cause through other initiatives, but do not have the means, know-how, and/or willingness to have that influence or advance a cause can create a cause campaign to enlist lobbyists or organizations, who have the capability to influence legislation or government decisions or advance causes, to influence legislation or government decisions and/or implement initiatives to advance the cause. A cause campaign created by an individual will allow people to initiate causes and demonstrate their level of demand for those causes. This type of campaign, like the event campaign created by a fan, has four phases: funding, voting, rewards, and cause. These phases function similar to those in the event campaign created by a fan. Like event organizers in an event campaign created by a fan, lobbyists who have the capability to influence legislation or government decisions or organizations who have the capability to advance a cause can bid on the funds raised by a campaign to utilize those funds to influence legislation or government decisions and implement initiatives that advance a cause as specified in the campaign. In the rewards phase, individuals who committed funds to the campaign will receive official documentation from the lobbyist or organization who submitted the winning bid indicating their engagement, duration of engagement, and detailing their services to be performed to advance the cause. The cause phase is the equivalent of the event phase in an event campaign created by a fan except, instead of selling tickets, the lobbyist or organization who submitted the winning bid can continue to raise funds to provide additional services and lengthen their duration of engagement with those who want to advance the cause specified in the campaign.

### IV. Event Campaign Created by an Event Organizer

Crowdplsr's event campaigns that are created by event organizers allow event organizers to test the market with their event ideas to make sure that they are giving fans what they want before committing their resources. Additionally, it is a way for event organizers to raise the necessary funds to get their event off the ground. Event campaigns that are created by event organizers go through two phases: funding and event.
1. Funding Phase

Any event organizer can create an event campaign to raise funds for an event that they are considering or require additional funds to get off the ground. In doing so, the event organizer will specify the desired feature or entertainment of the event, where they will hold the event, when the event will take place, what price they will sell tickets to the users who fund the campaign, which amenities they will offer at the event, a minimum or target amount of funding to be raised by the campaign, and an expiration date as to when the campaign will expire if the funding threshold is not met. At this point, the event campaign will be on display to all users in the Crowdplsr community. Fans interested in attending the specified event can demonstrate their level of interest by committing funds to purchase tickets to the event at the specified price before they are available to the general public. Moreover, the creator of the event campaign or any other user can share that campaign with those in their extended network. For example, they may share via social networks, blogs, email, mobile contact lists, and other mediums.
2. Event Phase

Once the minimum or target amount of funds is raised by the event campaign, the event campaign enters the event phase. In the event phase, fans who have committed funds will receive their tickets and the event organizer will have the opportunity to sell tickets to the event via the Crowdplsr platform. During the event phase, the price of tickets can be changed at any time by the event organizer. Tickets can be sold until there are none remaining or the event commences.

Crowdplsr will support any type of event, such as live music concerts, theatre, non-franchise sports, comedy, festivals, speakers (e.g., educational, motivational, religious, and political), tradeshows and celebrity appearances.
3. Applicability to Products and Services

In addition to events, the Crowdplsr system is applicable to products or services. Specifically, product or service campaigns created by a product or service provider could be utilized to test the demand for a product or service and raise the funds necessary to produce and distribute a product or service. Like event organizers in an event campaign, product or service providers who want to provide a product or service to a market, but do not have the means, know-how, and/or willingness to determine whether there is enough demand in the market to make to make the endeavor feasible or have the funding required to produce and distribute the product or service can create a product or service campaign to determine the amount of demand for the product or service in a market and raise the funding required to produce and distribute the product or service. A product or service campaign created by a product or service provider will allow people to demonstrate their level of demand for the specified products or services. This type of campaign, like the event campaign created by an event organizer, has two phases: funding and product or service. These phases function exactly like those in the event campaign created by an event organizer apart from some of the differences described in this section. The product or service phase is the equivalent of the event phase in an event campaign created by an event organizer, however, the product or service detailed in the campaign will be distributed and sold through the platform instead of tickets.
4. Applicability to Causes

In addition to events, the Crowdplsr system is applicable to causes. Specifically, cause campaigns created by an organization could be utilized to test the demand for a cause and raise the funds necessary to advance a cause. Like event organizers in an event campaign, organizations who want to advance a cause in a market, but do not have the means, know-how, and/or willingness to determine whether there is enough demand in the market to make the endeavor feasible or have the funding required to advance the cause can create a cause campaign to determine the amount of demand for the cause in a market and raise the funding required to advance the cause. A cause campaign created by an organization will allow people to demonstrate their level of demand for the specified cause. This type of campaign, like the event campaign created by an event organizer, has two phases: funding and cause. These phases function similar to those in the event campaign created by an event organizer. The cause phase is the equivalent of the event phase in an event campaign created by an event organizer except, instead of receiving tickets, individuals who committed funds to the campaign will receive official documentation from the organization that created the cause campaign indicating their engagement, duration of engagement, and detailing their services to be performed to advance the cause. Additionally, the organization can continue to raise funds to provide additional services and lengthen their duration of engagement with those who want to advance the cause specified in the campaign.

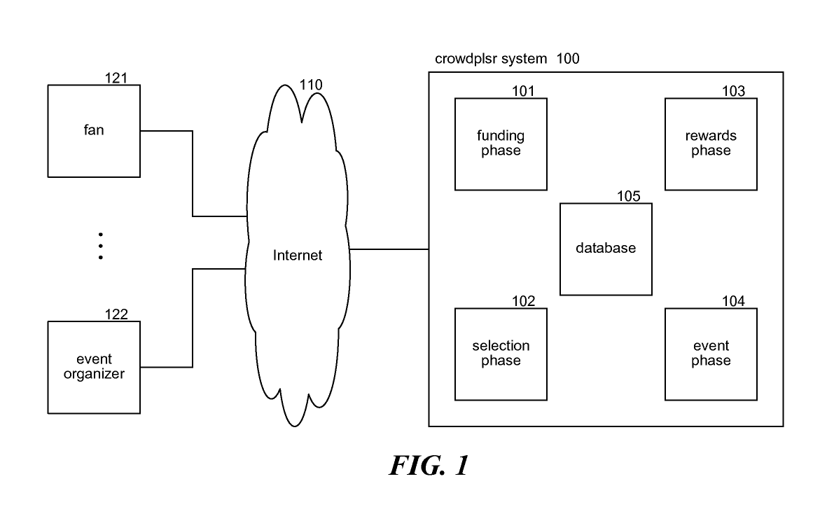

FIG. 1 is a block diagram that illustrates components of the Crowdplsr system supporting tour campaigns in some embodiments. The Crowdplsr system 100 connects to fan computers 121 and event organizer computers 122 via the Internet 110. The Crowdplsr system includes a funding phase component 101, a selection phase component 102, a rewards phase component 103, an event phase component 104, and a database 105. The funding phase component provides web pages through which an event organizer defines a multi-market tour including characteristics of the tour and expiration date of event campaigns for the tour campaign. The funding phase component also provides web pages through which any fan can create an event campaign including general proximity of an event in the tour campaign (e.g., stop in a tour). The funding phase component also provides web pages through which fans can fund an event campaign. The selection phase component provides web pages through which the event organizer can select event campaigns as stops in the tour by specifying venue, date, ticket prices for those who funded the event campaign, and so on. The rewards phase component provides web pages through which fans who committed funds to an event campaign can purchase tickets for the event before tickets are offered to the general public. The event phase component provides web pages through which the general public, after the end of the rewards phase for an event, can purchase tickets for the event. The database includes various tables for storing information about users, events, funding, and so on. Aspects of the Crowdplsr system may be implemented as applications that execute on fan and organizer computing devices (e.g., smart phones).

The computing devices on which the Crowdplsr system may be implemented through which fans and organizers may interface with the Crowdplsr system may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, and gaming devices. The computing devices may access computer-readable media that includes computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the Crowdplsr system. The data transmission media is used for transmitting data via transitory, propagating signals or carrier waves (e.g., electromagnetism) via a wired or wireless connection.

The Crowdplsr system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments.

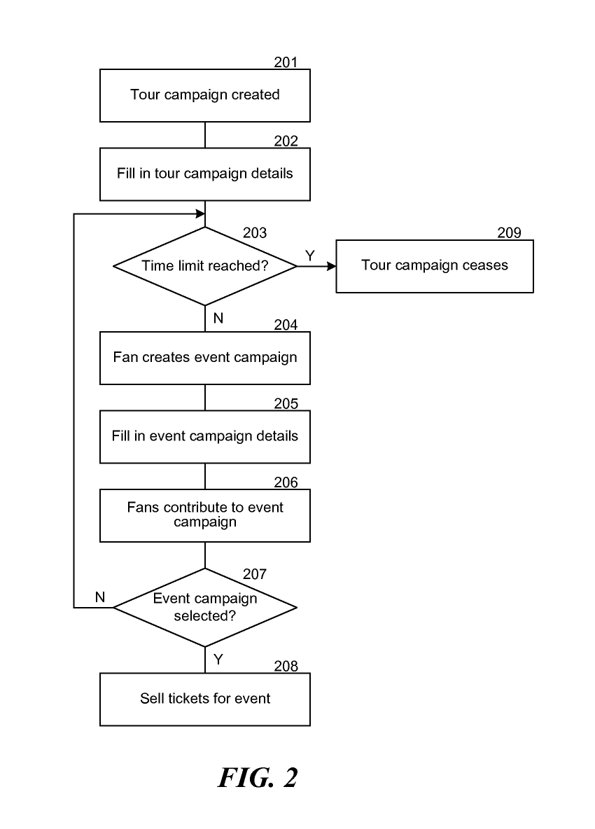

FIG. 2 is a flow diagram illustrating the overall flow of the processing of a tour campaign of the Crowdplsr system in some embodiments. In block 201, the Crowdplsr system starts the processing of the tour campaign by creating the tour campaign. In block 202, the Crowdplsr system allows an event organizer fills in the details of the tour campaign. In decision block 203, if the expiration time for the event campaigns has been reached, then the tour and/or event campaigns not selected cease in block 209, else the Crowdplsr system continues at block 204. In blocks 204-205, the fans can create event campaigns. In block 206, any fan can contribute to any event. In decision block 207, if the event organizer selects an event campaign, then the Crowdplsr system starts the rewards phase for that event campaign in block 208, else the Crowdplsr system waits for subsequent selection or expiration of a campaign.

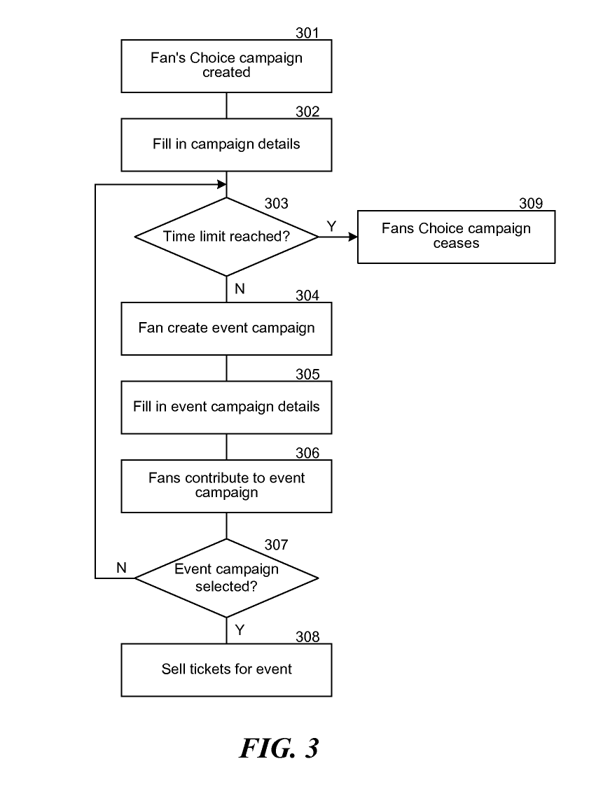

FIG. 3 is a flow diagram illustrating the overall flow of the processing of a fan's choice campaign of the Crowdplsr system in some embodiments. In block 301, the Crowdplsr system starts the processing by creating the fan's choice campaign. In block 302, the Crowdplsr system allows an event organizer to provide details of the campaign. In decision block 303, if the expiration time for the event campaigns has been reached, then the fan's choice and/or event campaigns not selected cease in block 309, else the Crowdplsr system continues at block 304. In blocks 304-305, the fans can create event campaigns. In block 306, any fan can contribute to any event. In decision block 307, if the event organizer selects an event campaign, then the Crowdplsr system starts the rewards phase for that event campaign in block 308, else the Crowdplsr system waits for subsequent selection or expiration of a campaign.

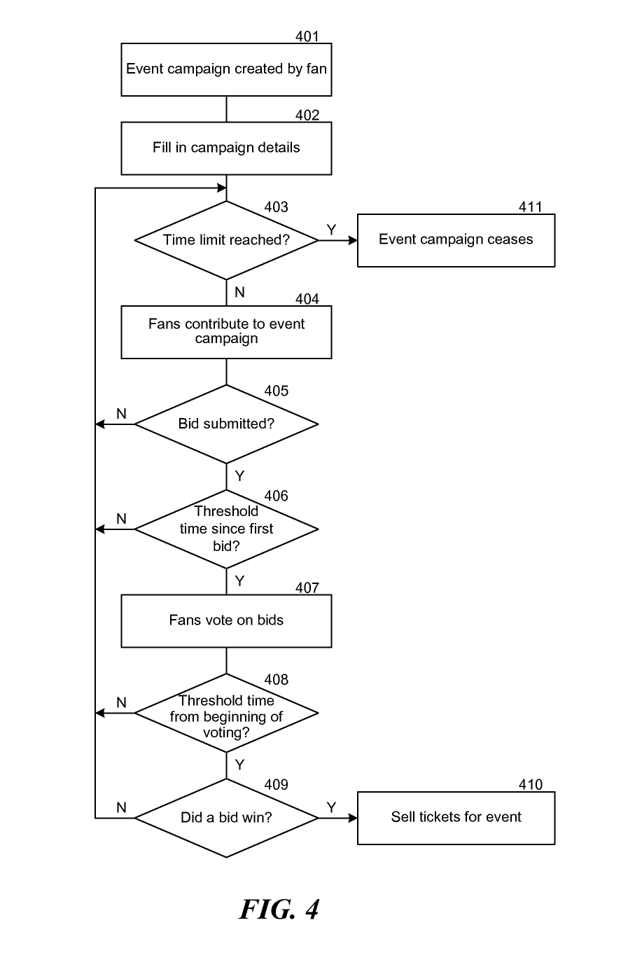

FIG. 4 is a flow diagram illustrating the overall flow of the processing of an event campaign created by a fan in some embodiments. In block 401, the Crowdplsr system starts the processing of creating an event campaign by a fan. In block 402, the Crowdplsr system allows the fan to provide details of the event campaign. In decision block 403, if the expiration time for the event campaign has been reached, then the event campaign ceases, else the Crowdplsr system continues at block 404. In block 404, the Crowdplsr system allows a fan to contribute to the event campaign. In decision block 405, if an event organizer has submitted a bid for the event campaign, then the Crowdplsr system continues at block 406, else the Crowdplsr system continues at block 403. In decision block 406, if a time period has expired since a bid was submitted, then the Crowdplsr system continues at block 407, else the Crowdplsr system continues at block 403. In block 407, the Crowdplsr system receives votes from the fans on the bids. In decision block 408, if a time period has expired since the voting started, then the Crowdplsr system continues at block 409, else the Crowdplsr system continues at block 403. In decision block 409, if a bid won, then the Crowdplsr system enters the rewards phase in block 410, else the Crowdplsr system continues at block 403. In some embodiments, once the voting starts, the voting continues even though the expiration time for the event campaign has been reached.

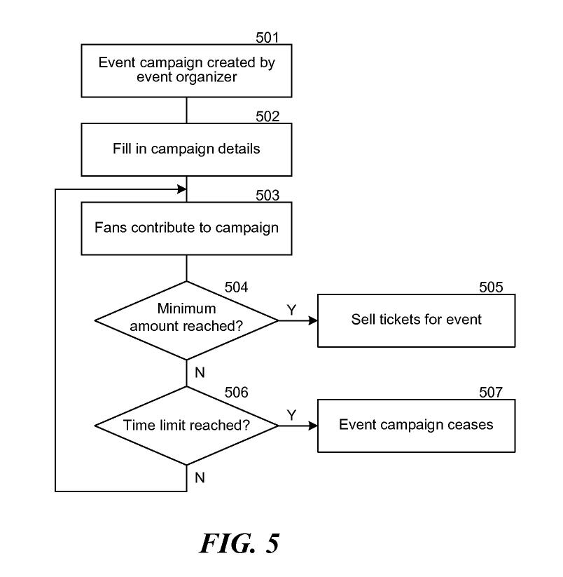

FIG. 5 is a flow diagram that illustrates the overall flow of the processing of an event campaign created by an event organizer in some embodiments. In block 501, the Crowdplsr system starts the processing of creating the event campaign by the event organizer. In block 502, the Crowdplsr system allows the event organizer to provide details for the event campaign. In block 503, the Crowdplsr system allows fans to contribute to the campaign. In decision block 504, if the minimum amount of contributions has been reached, then the Crowdplsr system enters the rewards phase in block 505, else the Crowdplsr system continues at block 506. In decision block 506, if the expiration time has been reached, then the Crowdplsr system ceases the event campaign in block 507, else the Crowdplsr system loops to block 503 to allow fans to contribute.

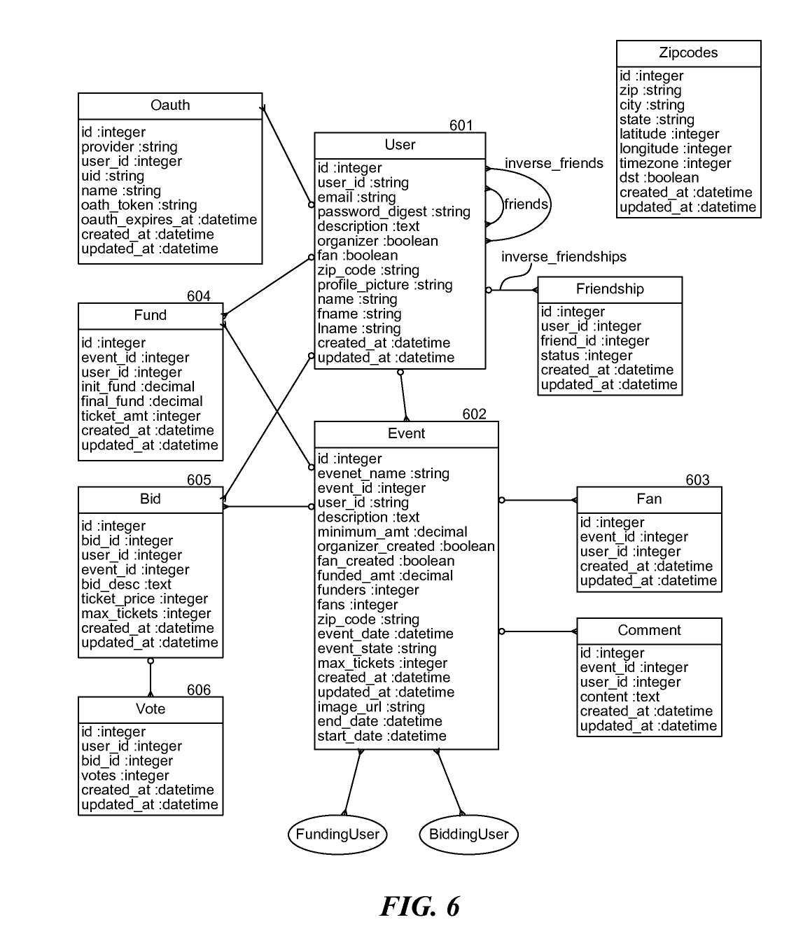

FIG. 6 is a block diagram illustrating the tables of the database of the Crowdplsr system supporting event campaigns created by a fan or an event organizer in some embodiments. The database includes a user table 601, an event table 602, a fan table 603, a fund table 604, a bid table 605, and a vote table 606. When a user registers with the Crowdplsr system, the Crowdplsr system stores an entry in the user table for that user. When a user creates an event campaign, the Crowdplsr system stores an entry defining the event campaign in the event table. When a user registers as a fan for an event campaign, the Crowdplsr system stores an entry mapping the fan to that event campaign in the fan table. When a user funds an event campaign, the Crowdplsr system stores an entry indicating the funding amount in the fun table. When an event organizer submits a bid for the event campaign, the Crowdplsr system stores an entry in the bid table. When a user votes on a bid, the Crowdplsr system stores an entry in the vote table.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A computing system for organizing campaigns, the computing system comprising:
a computer-readable storage medium storing computer-executable instructions of
a funding phase component to define by a campaign organizer a campaign, define by option creators options for the campaign, and fund by funding users the options; and
a selection phase component to select by the campaign organizer an option for the campaign based, at least in part, on the funding of the funding users; and
a processor for executing computer-executable instructions stored in the computer-readable storage medium.

2. The computing system of claim 1 wherein the computer-readable storage medium further stores computer-executable instructions of a rewards phase component to reward funding users for funding the selected option.

3. The computing system of claim 2 wherein the campaign is a tour campaign and the defining of the campaign includes specifying an offering and the defining of options includes specifying a proposed offering market for the offering.

4. The computing system of claim 3 wherein an offering is a performance and the proposed offering market specifies a location for an occurrence of the performance.

5. The computing system of claim 3 wherein an offering is a product or service and the proposed offering market specifies a location for offering the product or service.

6. The computing system of claim 3 wherein an offering is a cause and the proposed offering market specifies a location where the cause is to be promoted.

7. The computing system of claim 3 wherein the rewards phase component rewards funding users by providing the offering to the funding users based on their funding of a proposed offering market.

8. The computing system of claim 2 wherein the campaign is a fan's choice campaign and the defining of the campaign includes specifying an offering market and the defining of options includes specifying a proposed offering.

9. The computing system of claim 8 wherein an offering market is a location for an offering and a proposed offering is a performance for the location.

10. The computing system of claim 8 wherein an offering market is a location and the proposed offering is a product or a service to be available at the location.

11. The computing system of claim 8 wherein the offering market is a location and the proposed offering is a cause to be promoted at the location.

12. The computing system of claim 8 wherein the rewards phase component rewards funding users by providing the offering to the funding users based on their funding of a proposed offering.

13. A method performed by a computing system for organizing campaigns, the method comprising:
receiving from a campaign organizer a definition of a campaign having an offering for an offering market;
receiving an indication of a funding by funding users of the offering;
receiving bids to fulfill the offering at the offering market;
receiving from funding users votes for a received bid;
receiving from the campaign organizer a selection of a bid based, at least in part, on votes of the funding users; and
providing a reward to funding users for funding the selected offering.

14. The method of claim 13 wherein an offering is a performance and the offering market specifies a location for the performance.

15. The method of claim 13 wherein an offering is a product or service and the offering market specifies a location for offering the product or service.

16. The method of claim 13 wherein an offering is a cause and the offering market specifies a location where the cause is to be promoted.

17. A computer-readable storage medium storing computer-executable instructions for controlling a computing device to organize a tour campaign for an event, the computer-executable instructions comprising instructions that control the:
defining by a campaign organizer the event for the campaign, defining by event market creators proposed markets for occurrences of the event;
funding by funding users the proposed markets;
selecting by the campaign organizer proposed markets for the campaign based, at least in part, on the funding of the funding users; and
rewarding funding users for funding the selected proposed markets.

18. The computer-readable storage medium of claim 17 wherein the event is a performance by a performer and the proposed markets specify proposed venues for performances.

19. The computer-readable storage medium of claim 17 wherein funding users are rewarded with tickets to occurrences of the event in exchange for their funding.

20. The computer-readable storage medium of claim 19 wherein the computer-executable instructions further comprise instructions that control the allowing of non-funding users to purchase tickets after the funding users are rewarded.
